(19) United States
(12) Patent Application Publication
(10) Pub. No.: US 2016/0201716 A1
(43) Pub. Date: Jul. 14, 2016

(54) CONTROL CABLE LINER

(71) Applicant: KYUNG CHANG INDUSTRIAL CO., Ltd., Daegu (KR)

(72) Inventors: Kyu-Jung Kim, Daegu (KR); Chang-Min Lee, Daegu (KR)

(21) Appl. No.: 14/843,789

(22) Filed: Sep. 2, 2015

(30) Foreign Application Priority Data
Jan. 14, 2015 (KR) 10-2015-0006671

(51) Int. Cl. F16C 1/26

(52) U.S. Cl. CPC F16C 1/26

(57) ABSTRACT

A control cable liner may be provided which has a cylindrical shape and a hollow portion into which an inner cable is inserted. A plurality of protrusions are formed on the inner surface of the hollow portion.

### CROSS-REFERENCE TO RELATED APPLICATION

This application claims priority to and benefit of Republic of Korea Patent Application No. 10-2015-0006671 filed on Jan. 14, 2015, which are incorporated by reference herein in its entirety.

### BACKGROUND

1. Field

The present invention relates to a control cable liner.

2. Description of Related Art

Generally, a machinery such as a vehicle is equipped with many various kinds of cables. Here, a control cable which is used for forward or backward movement and shifting of the vehicle is comprised of an outer casing and an inner cable. A gap may be formed between the outer casing and the inner cable. When the inner cable reciprocatively moves by the forward or backward movement or shifting of the vehicle, backlash is caused between the outer casing and the inner cable.

In order to reduce the backlash, in the past, a liner of the outer casing has been formed to have a cylindrical shape or a polygonal shape.

However, in this case, the sliding resistance of the control cable is increased and the transmission efficiency for shifting operation is decreased, so that shift feeling is degraded.

Moreover, since a sliding area between the liner of the outer casing and the inner cable is large, a friction force between the liner and the inner cable is increased and abrasion is created with the increase of the number of the operations. As a result, the gap between the liner and the inner cable becomes larger, so that backlash and rattle noise increase.

Accordingly, research is required to develop a control cable liner for minimizing the frictional resistance between the core and the liner of the vehicle control cable.

### SUMMARY

One embodiment is a control cable liner. The control cable liner has a cylindrical shape and a hollow portion into which an inner cable is inserted. A plurality of protrusions are formed on the inner surface of the hollow portion.

### BRIEF DESCRIPTION OF THE DRAWINGS

FIG. 1 is a perspective view showing an exploded portion of a control cable according to an embodiment of the present invention;

FIG. 2 is a cross sectional view of a liner according to the embodiment of the present invention;

FIGS. 3 to 5 are views for describing the operations of the liner and an inner cable inserted into the liner in accordance with the embodiment of the present invention;

FIGS. 6 and 7 are views for describing a case where lubricant is inserted between the inner cable and the liner; and

FIG. 8 is a view for describing a case where the liner is surrounded by a coil, a strand wire, and a cover in accordance with the embodiment of the present invention, so that an external force is applied toward the center of the liner.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereafter, a control cable liner according to an embodiment of the present invention will be described with reference to the accompanying drawings.

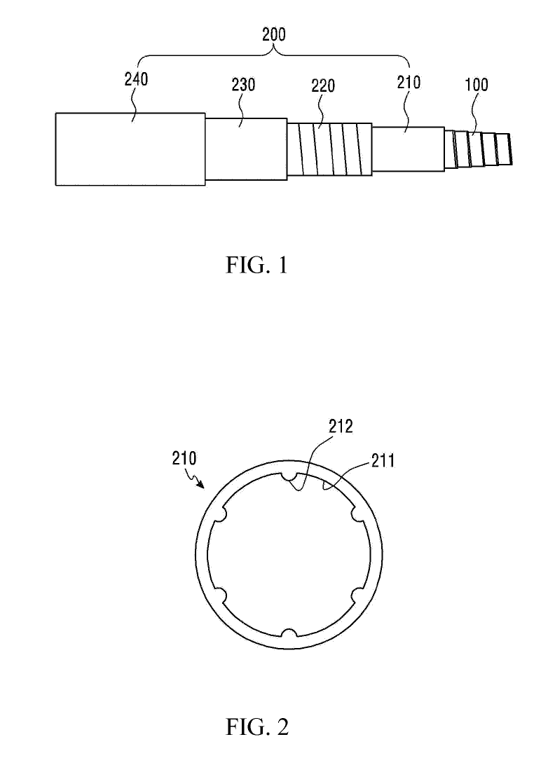

FIG. 1 is a perspective view showing an exploded portion of a control cable according to the embodiment of the present invention.

Referring to FIG. 1, the control cable according to the embodiment of the present invention includes an inner cable 100 and an outer casing 200.

The inner cable 100 is formed to have a cylindrical shape and is inserted within a liner 210.

The outer casing 200 includes the liner 210 into which the inner cable 100 is inserted, a coil 220 which is formed to surround the outer circumferential surface of the liner 210, a strand wire 230 which surrounds the coil 220, and a cover 240 which is coated on the circumference of the strand wire 230. Here, the coil 220 and the strand wire 230 may be made of a metal member, and the cover 240 may be made of a rubber material.

FIG. 2 is a cross sectional view of a liner according to the embodiment of the present invention.

Referring to FIG. 2, the liner 210 may have a cylindrical shape and a circular hollow portion into which the inner cable 100 is inserted. A plurality of protrusions 212 may be circumferentially formed at a regular interval on the inner circumferential surface 211 of the hollow portion. Here, the protrusion 212 may be formed to have a shape which allows a sliding surface contacting with the outer circumferential surface of the inner cable 100 to have a minimum size. For example, the protrusion 212 may have a hemispheric cross section, a triangular cross section, etc.

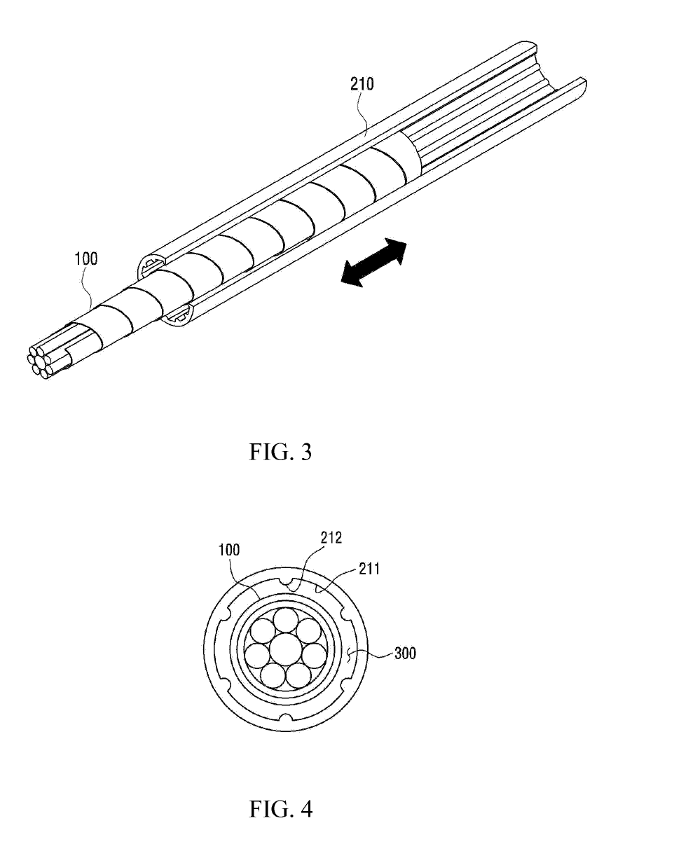

FIGS. 3 to 5 are views for describing the operations of the liner and an inner cable inserted into the liner in accordance with the embodiment of the present invention.

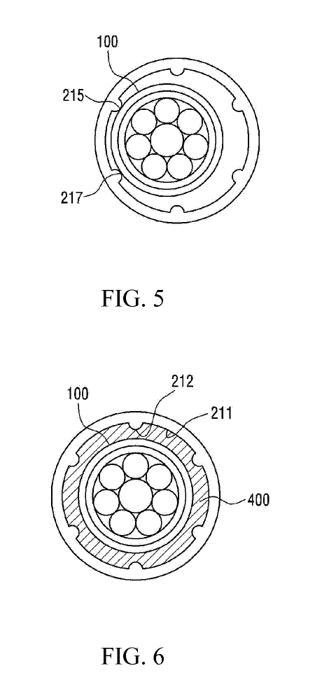

Particularly, FIG. 3 is a view for describing the operations of the liner and the inner cable. FIG. 4 is a cross sectional view showing the liner and the inner cable inserted into the liner. FIG. 5 is a cross sectional view showing the liner and the inner cable which has contacted the protrusion of the liner.

Referring to FIGS. 3 to 5, the inner cable 100 is inserted within the hollow portion of the liner 210. A void 300 may be formed between the outer circumferential surface of the inner cable 100 inserted into the liner 210 and the inner circumferential surface 211 of the hollow portion of the liner 210.

Since the void 300 is formed between the hollow portion of the liner 210 and the inner cable 100, the inner cable 100 moves forward and backward in a longitudinal direction of the liner 210 by the operation of the control cable. Here, the outer circumferential surface of the inner cable 100 may contact some of the plurality of protrusions formed on the inner circumferential surface 211 of the hollow portion of the liner 210. For example, as shown in FIG. 5, by the forward and backward movement of the inner cable 100, the outer circumferential surface of the inner cable 100 may contact the protrusions 215 and 217 formed on the inner circumferential surface 211 of the hollow portion of the liner 210. As a result, since the inner cable 100 may contact only some of the plurality of protrusions formed on the inner circumferential surface 211 of the hollow portion of the liner 210, frictional resistance between the inner cable 100 and the liner 210 is minimized, so that backlash and rattle noise can be reduced and shift operation can be smoothly performed, thereby increasing operation feeling.

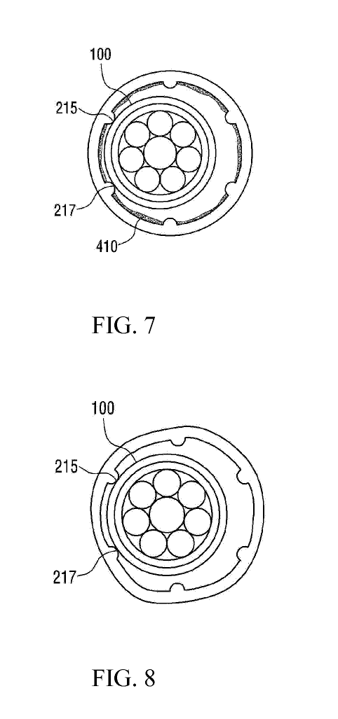

FIGS. 6 and 7 are views for describing a case where lubricant is inserted between the inner cable and the liner.

Referring to FIGS. 6 and 7, lubricant 400 may be injected into the void 300 formed between the outer circumferential surface of the inner cable 100 and the inner circumferential surface 211 of the hollow portion of the liner 210. Due to the lubricant 400 injected into the void 300, an excessive operating force is not required for the operation of the control cable, so that shift operation can be smoothly performed. This lubricant coheres between the inner cable 100 and the liner 210 with the lapse of time, and thus, increases a contact area between the inner cable 100 and the liner 210. As a result, frictional resistance increases and shift operation is not smoothly performed.

However, as shown in FIG. 7 in the embodiment of the present invention, the lubricant 410 coheres between the plurality of protrusions formed on the inner circumferential surface 211 of the hollow portion of the liner 210. Therefore, the inner cable 100 comes in contact with the protrusions 215 and 217 formed on the inner circumferential surface 211 of the hollow portion of the liner 210, so that frictional resistance between the inner cable 100 and the liner 210 can be minimized. As a result, backlash and rattle noise can be reduced and shift operation can be smoothly performed, thereby increasing operation feeling.

FIG. 8 is a view for describing a case where the liner is surrounded by a coil, a strand wire, and a cover in accordance with the embodiment of the present invention, so that an external force is applied toward the center of the liner.

In the control cable, an external force is applied toward the center of the liner by the coil, the strand wire, and the cover which surround the outer circumferential surface of the liner 210, so that the shape of the liner 210 may be, as shown in FIG. 8, changed. Even in this case, since the outer circumferential surface of the inner cable 100 contacts only some of the plurality of protrusions formed on the inner circumferential surface 211 of the hollow portion of the liner 210, frictional resistance between the inner cable 100 and the liner 210 can be minimized.

The features, structures and effects and the like described in the embodiments are included in one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although preferred embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A control cable liner which has a cylindrical shape and a hollow portion into which an inner cable is inserted, wherein a plurality of protrusions are formed on an inner surface of the hollow portion.

2. The control cable liner of claim 1, wherein a void is formed between an outer circumferential surface of the inner cable and the inner surface of the hollow portion.

3. The control cable liner of claim 1, wherein the protrusion is formed to have a shape which allows a sliding surface contacting with the inner cable to have a minimum size.
